(19) United States
(12) Patent Application Publication
(10) Pub. No.: US 2010/0147335 A1
(43) Pub. Date: Jun. 17, 2010

(54) LIQUID PROCESSING APPARATUS, LIQUID PROCESSING METHOD, AND STORAGE MEDIUM

(75) Inventors: Norihiro Ito, Kumamoto-Ken (JP); Yuji Kamikawa, Saga-Ken (JP)

Correspondence Address: BURR & BROWN, PO BOX 7068, SYRACUSE, NY, 13261-7068, US

(73) Assignee: Tokyo Electron Limited, Minato-Ku (JP)

(21) Appl. No.: 12/596,889

(22) PCT Filed: Jan. 27, 2009
(86) PCT No.: PCT/JP2009/051247

§ 371 Date: Oct. 21, 2009

(30) Foreign Application Priority Data
Feb. 14, 2008 (JP) 2008-033509

(51) Int. Cl. B08B 3/00

(52) U.S. Cl. 134/33; 134/157

(57) ABSTRACT

A liquid processing apparatus includes: a hollow holding plate to hold an object to be processed; a hollow outer rotary shaft fixedly joined to the holding plate; a lift pin plate having a lift pin to support the object; an inner rotary shaft fixedly joined to the lift pin plate; and a lifting member to raise and lower the lift pin plate to locate the lift pin plate on an upper position and a lower position. Inside the inner rotary shaft, there is disposed a cleaning-liquid supply part to supply a cleaning liquid to the object to be processed. An outer rotary drive part is joined to the outer rotary shaft, the outer rotary drive part being configured to rotate the outer rotary shaft. An inner rotary drive part is joined to the inner rotary shaft, the inner rotary drive part being configured to rotate the inner rotary shaft.

### CROSS REFERENCE TO RELATED APPLICATIONS

This application is based upon and claims the benefit of priority from the prior Japanese Patent Application No. 2008-33509 filed on Feb. 14, 2008, the entire contents of which are incorporated herein by reference.

### FIELD OF THE INVENTION

The present invention relates to a liquid processing apparatus and a liquid processing method, in which a cleaning liquid is supplied to an object to be processed that is rotated so as to clean the object to be processed, and to a storage medium configured to implement the liquid processing method.

### BACKGROUND ART

As described in JP9-290197A, there has been conventionally known a liquid processing apparatus including: a hollow bottom plate configured to hold an object to be processed such as a semiconductor wafer (hereinafter referred to also as “wafer”); a rotary shaft fixedly connected to the bottom plate, the rotary shaft being configured to be rotated by a spin motor; a supply duct configured to supply a cleaning liquid to a wafer held by the bottom plate; and a substrate lift pin capable of being raised so as to support the wafer from below.

In the conventional liquid processing apparatus, there is a possibility that cleaning liquids, such as a chemical liquid and a rinse liquid used for cleaning a wafer, might adhere to the substrate lift pin via a through hole. Thus, after drying a wafer, when the wafer is raised by the substrate lift pin and is delivered to a transfer robot, liquid droplets of the cleaning liquid adhering to the substrate lift pin may adhere to a rear surface of the wafer.

When the cleaning liquid adheres to the wafer, watermarks are formed on the wafer itself to which the liquid droplets adhere. In addition thereto, watermarks are generated on other wafers contained in a carrier into which the wafer has been brought, because of an increase in humidity in the carrier.

### DISCLOSURE OF THE INVENTION

The present invention has been made in view of the above circumstances. The present invention provides a liquid processing apparatus and a liquid processing method that can prevent a cleaning liquid from remaining on a member for raising a substrate, to thereby prevent adhesion of the cleaning liquid to a rear surface of the substrate, whereby formation of watermarks on the object to be processed can be prevented, and a storage medium configured to implement the liquid processing method.

A liquid processing apparatus according to the present invention comprises:

a hollow holding plate configured to hold an object to be processed;

a hollow outer rotary shaft fixedly joined to the holding plate;

a lift pin plate disposed in a hollow space of the holding plate, and having a lift pin configured to support the object to be processed;

an inner rotary shaft extended in a hollow space of the outer rotary shaft, and fixedly joined to the lift pin plate;

a cleaning-liquid supply part disposed inside the inner rotary shaft, the cleaning-liquid supply part being configured to supply a cleaning liquid to the object to be processed held by the holding plate;

a lifting member configured to raise and lower the lift pin plate so as to locate the lift pin plate on an upper position and a lower position;

an outer rotary drive part joined to the outer rotary shaft, the outer rotary drive part being configured to rotate the outer rotary shaft; and

an inner rotary drive part joined to the inner rotary shaft, the inner rotary drive part being configured to rotate the inner rotary shaft.

Due to this structure, the cleaning liquid can be prevented from pooling in the lift pin plate, and the cleaning liquid can be prevented from remaining on the lift pin. Thus, adhesion of the cleaning liquid on a rear surface of the object to be processed can be prevented.

In the liquid processing apparatus according to the present invention,

a rotational direction of the outer rotary shaft rotated by the outer rotary drive part can be the same as a rotational direction of the inner rotary shaft rotated by the inner rotary drive part;

a rotational speed of the outer rotary shaft rotated by the outer rotary drive part can be the same as a rotational speed of the inner rotary shaft rotated by the inner rotary drive part; and

a sealing member can be provided between the lift pin plate and the holding plate.

Due to this structure, the cleaning liquid or the like can be prevented from entering the hollow space of the outer rotary shaft from between the lift pin plate and the holding plate.

In the liquid processing apparatus according to the present invention,

a distance between a distal end of the lift pin of the lift pin plate and a lower surface of the object to be processed held by the holding plate can be 5 mm or smaller, when the lift pin plate is located on the lower position.

Due to this structure, the end of the lift pin can be cleaned by the cleaning liquid flowing along the lower surface of the object to be processed. Thus, when the distal end of the lift pin is brought into contact with the rear surface of the object to be processed, contaminations adhering to the distal end of the lift pin can be prevented from moving onto the rear surface of the object to be processed.

In the liquid processing apparatus according to the present invention,

the lift pin of the lift pin plate can be located in the vicinity of a periphery of the holding plate.

Due to this structure, after the rear surface of the object to be processed has been cleaned, the distal end of the lift pin can be cleaned. Thus, when the distal end of the lift pin is brought into contact with the rear surface of the object to be processed, contaminations adhering to the distal end of the lift pin can be more reliably prevented from moving onto the rear surface of the object to be processed.

In the liquid processing apparatus according to the present invention,

a rotational speed of the holding plate rotated by the outer rotary drive part and a rotational speed of the lift pin plate rotated by the inner rotary drive part can be different from each other.

Due to this structure, for example, the rotational speed of the lift pin plate can be made faster than the rotational speed of the holding plate, whereby the cleaning liquid on the lift pin plate can be more reliably removed.

A liquid processing method according to the present invention is a liquid processing method with the use of a liquid processing apparatus including: a hollow holding plate; a hollow outer rotary shaft fixedly joined to the holding plate; a lift pin plate disposed in a hollow space of the holding plate, and having a lift pin; an inner rotary shaft extended in a hollow space of the outer rotary shaft, and fixedly joined to the lift pin plate; a cleaning-liquid supply part disposed inside the inner rotary shaft; a lifting member configured to raise and lower the lift pin plate so as to locate the lift pin plate on an upper position and a lower position; an outer rotary drive part joined to the outer rotary shaft; and an inner rotary drive part joined to the inner rotary shaft; the liquid processing method comprising:

locating the lift pin plate on the upper position by the lifting member;

supporting an object to be processed by the lift pin of the lift pin plate;

locating the lift pin plate on the lower position by the lifting member;

holding the object to be processed by the holding plate;

rotating the outer rotary shaft by the outer rotary drive part, so that the object to be processed held by the holding plate is rotated,

rotating the inner rotary shaft by the inner rotary drive part, so that the lift pin plate is rotated;

supplying a chemical liquid to the object to be processed by the cleaning-liquid supply part; and

supplying a rinse liquid to the object to be processed by the cleaning-liquid supply part.

Due to this method, the cleaning liquid can be prevented from pooling in the lift pin plate, and the cleaning liquid can be prevented from remaining on the lift pin. Thus, adhesion of the cleaning liquid on a rear surface of the object to be processed can be prevented.

In the liquid processing method,

a rotational speed of the object to be processed held by the holding member and a rotational speed of the lift pin plate can be different from each other.

Due to this method, for example, the rotational speed of the lift pin plate can be made faster than the rotational speed of the object to be processed held by the holding plate, whereby the cleaning liquid on the lift pin plate can be more reliably removed.

A storage medium according to the present invention is a storage medium storing a computer program for causing a computer to implement a liquid processing method,

the liquid processing method performed with the use of a liquid processing apparatus including: a hollow holding plate; a hollow outer rotary shaft fixedly joined to the holding plate; a lift pin plate disposed in a hollow space of the holding plate, and having a lift pin; an inner rotary shaft extended in a hollow space of the outer rotary shaft, and fixedly joined to the lift pin plate; a cleaning-liquid supply part disposed inside the inner rotary shaft; a lifting member configured to raise and lower the lift pin plate so as to locate the lift pin plate on an upper position and a lower position; an outer rotary drive part joined to the outer rotary shaft; and an inner rotary drive part joined to the inner rotary shaft;

the liquid processing method comprising:

locating the lift pin plate on the upper position by the lifting member;

supporting an object to be processed by the lift pin of the lift pin plate;

locating the lift pin plate on the lower position by the lifting member;

holding the object to be processed by the holding plate;

rotating the outer rotary shaft by the outer rotary drive part, so that the object to be processed held by the holding plate is rotated;

rotating the inner rotary shaft by the inner rotary drive part, so that the lift pin plate is rotated;

supplying a chemical liquid to the object to be processed by the cleaning-liquid supply part; and

supplying a rinse liquid to the object to be processed by the cleaning-liquid supply part.

Due to this structure, the cleaning liquid can be prevented from pooling in the lift pin plate, and the cleaning liquid can be prevented from remaining on the lift pin. Thus, adhesion of the cleaning liquid on a rear surface of the object to be processed can be prevented.

According to the present invention, since the inner rotary shaft is rotated by the inner rotary drive part so that the lift pin plate is rotated, the cleaning liquid can be prevented from pooling in the lift pin plate, and the cleaning liquid can be prevented from remaining on the lift pin. Thus, adhesion of the cleaning liquid on a rear surface of the object to be processed can be prevented. Accordingly, formation of watermarks on the object to be processed can be prevented.

### BRIEF DESCRIPTION OF THE DRAWINGS

FIG. 1 is a lateral sectional view showing a driving manner of a liquid processing apparatus in one embodiment of the present invention.

FIG. 2 is a lateral sectional view showing the liquid processing apparatus in the embodiment of the present invention.

FIG. 3 is a flowchart showing a flow of a liquid processing method performed by the liquid processing apparatus in the embodiment of the present invention.

FIG. 4 is a lateral sectional view showing the liquid processing apparatus in another embodiment of the present invention.

FIG. 5 is a lateral sectional view showing the liquid processing apparatus in still another embodiment of the present invention.

### MODE FOR CARRYING OUT THE INVENTION

### Embodiment

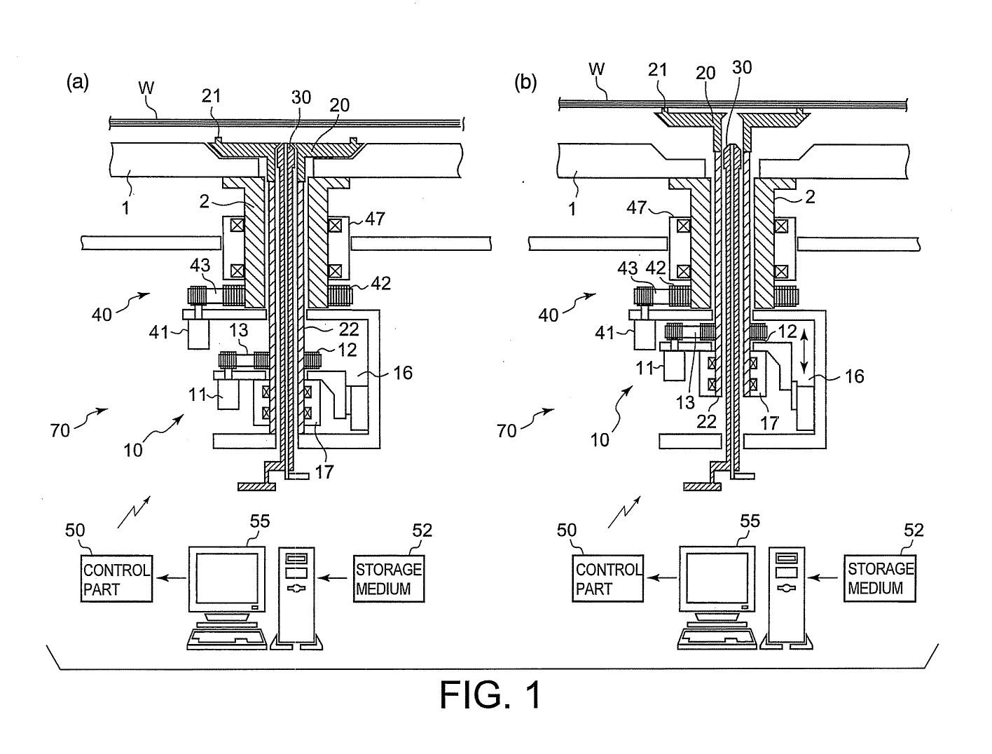

An embodiment of the liquid processing apparatus and an embodiment of the liquid processing method according to the present invention are described herebelow with reference to the drawings. FIGS. 1(a) (b) to FIG. 5 are the views showing the embodiment of the present invention.

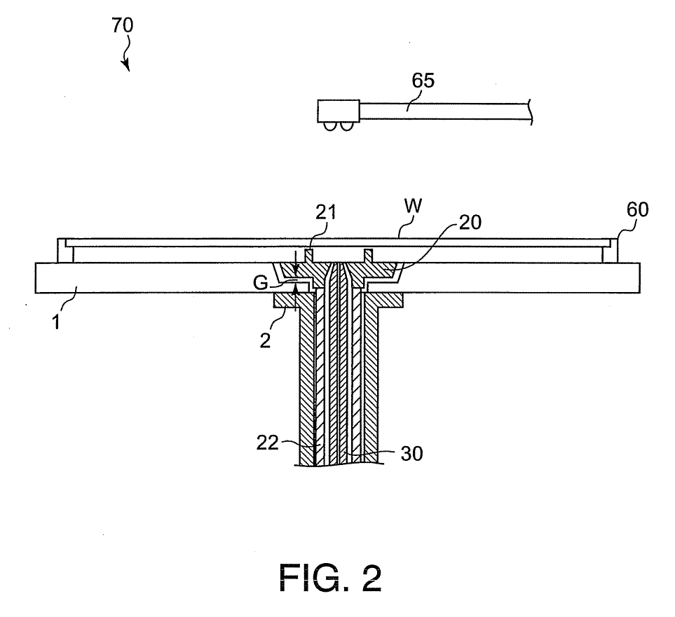

As shown in FIGS. 1(a), 1(b), and 2, a liquid processing apparatus 70 includes: a hollow holding plate 1 configured to hold an object to be processed such as a semiconductor wafer W (hereinafter referred to also as “wafer”); a hollow outer rotary shaft 2 fixedly joined to the holding plate 1; a lift pin plate 20 arranged in the hollow space of the holding plate 1 and having a lift pin 21 for supporting a wafer W; and an inner rotary shaft 22 vertically extended in the hollow space of the outer rotary shaft 2, and fixedly joined to the lift pin plate 20. As shown in FIG. 2, the holding plate 1 holds the wafer W by means of a holding member 60.

As shown in FIGS. 1(a) and 1(b), an outer drive part 40 for rotating the outer rotary shaft 2 is joined to the outer rotary shaft 2, and an inner rotary drive part 10 for rotating the inner rotary shaft 22 is joined to the inner rotary shaft 22. In addition, as shown in FIGS. 1(a) and 1(b), a bearing 47 is disposed on a position outward a periphery of the outer rotary shaft 2, and a bearing 17 is disposed on a position outward a periphery of the inner rotary shaft 22.

As shown in FIGS. 1(a) and 1(b), the outer rotary drive part 40 includes a pulley 42 disposed on a position outward the periphery of the outer rotary shaft 2, and a motor 41 for imparting a driving force to the pulley 42 through a driving belt 43.

As shown in FIGS. 1(a) and 1(b), the inner rotary drive part 10 includes a pulley 12 disposed on a position outward the periphery of the inner rotary shaft 22, and a motor 11 for imparting a driving force to the pulley 12 through a driving belt 13.

As shown in FIGS. 1(a) and 1(b), the inner rotary shaft 22 and the lift pin plate 20 have hollow shapes. Inside the inner rotary shaft 22 and the lift pin plate 20 (in the hollow spaces thereof), there is vertically extended a rear-side cleaning-liquid supply part (cleaning-liquid supply part) 30 configured to supply a cleaning liquid onto a rear surface of a wafer W held by the holding plate 1.

As shown in FIGS. 1(a) and 1(b), the inner rotary shaft 22 is equipped with a lifting member 16 that raises and lowers the lift pin plate 20 and the inner rotary shaft 22 so as to locate them on an upper position and a lower position. The lifting member 16 raises and lowers the inner rotary shaft 22 so as to raise and lower the lift pin plate 20.

As shown in FIG. 2, disposed above the holding plate 1 is a front-side cleaning-liquid supply part 65 configured to supply a cleaning liquid onto a front surface of a wafer W held by the holding plate 1.

The cleaning liquid means a chemical liquid and a rinse liquid. As the chemical liquid, there may be used diluted hydrofluoric acid, ammonia peroxide mixture (SC1), hydrochloric peroxide mixture (SC2) or the like. Meanwhile, for example, a deionized water (DIW) may be used as the rinse liquid

In addition, a gas for drying made of N₂ or the like can be supplied from the rear-side cleaning-liquid supply part 30, and a liquid for drying made of IPA (isopropyl alcohol) or the like can be supplied from the front-side cleaning-liquid supply part 65.

As shown in FIG. 2, even when the lift pin plate 20 is located on the lower position, a gap G is provided between the lift pin plate 20 and the holding plate 1. A gas such as N₂ can be jetted (purged) unpwardly through the gap G between the lift pin plate 20 and the holding plate 1.

Next, an operation of the embodiment as described above is described.

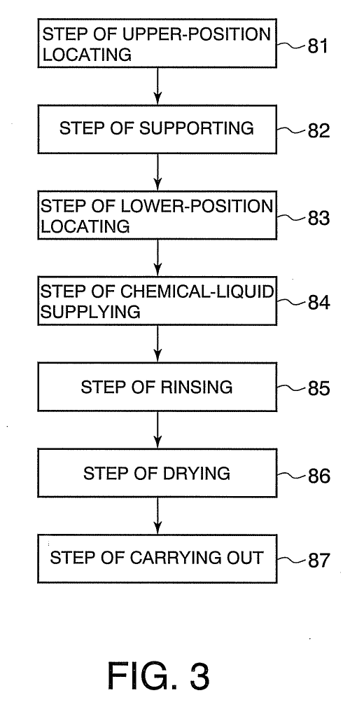

At first, the lift pin plate 20 is located on the upper position (position to which a wafer transfer robot transfers a wafer W) by the lifting member 16 (step of upper-position locating 81) (see, FIG. 1(b) and FIG. 3). More specifically, the inner rotary shaft 22 is located on the upper position by the lifting member 16, so that the lift pin plate 20 fixedly joined to the inner rotary shaft 22 is located on the upper position.

Then, the wafer W is received by the lift pin 21 of the lift pin plate 20 from the wafer transfer robot (not shown), and the wafer W is supported by the lift pin 21 (step of supporting 82) (see, FIG. 1(b) and FIG. 3).

Then, the lift pin plate 20 is located on the lower position (position at which the wafer W is processed by a cleaning liquid) by the lifting member 16 (step of lower-position locating 83) (see, FIG. 1(a) and FIG. 3). More specifically, the inner rotary shaft 22 is located on the lower position by the lifting member 16, so that the lift pin plate 20 fixedly joined to the inner rotary shaft 22 is located on the lower position.

When the lift pin plate 20 is located on the lower position in this manner, the wafer W is held by the holding member 60 of the holding plate 1 (step of holding) (see, FIG. 2).

Then, the outer rotary shaft 2 is rotated by the outer rotary drive part 40, so that the wafer W held by the holding plate 1 is rotated (step of rotating outer rotary shaft) (see, FIG. 1(a)). After the holding plate 1 has been rotated (or simultaneously therewith), the inner rotary shaft 22 is rotated by the inner rotary drive part 10, so that the lift pin plate 20 is rotated (step of rotating inner rotary shaft) (see, FIG. 1(a)).

At this time, a driving force is imparted from the motor 41 to the pulley 42 through the driving belt 43, whereby the outer rotary shaft 2 is rotated, and a driving force is imparted from the motor 11 to the pulley 12 through the driving belt 13, whereby the inner rotary shaft 22 is rotated.

During the rotation of the wafer W held by the holding plate 1 and the lift pin plate 20, the following steps are performed.

At first, a chemical liquid is supplied to the wafer W by the front-side cleaning-liquid supply part 65 and the rear-side cleaning-liquid supply part 30 (step of chemical-liquid supplying 91) (see, FIGS. 2 and 3). Namely, the chemical liquid is supplied to the front surface of the wafer W by the front-side cleaning-liquid supply part 65, and the chemical liquid is supplied to the rear surface of the wafer W by the rear-surface cleaning-liquid supply part 30.

At this step, in order to prevent the chemical liquid from entering the hollow space of the outer rotary shaft 2 through the gap G between the lift pin plate 20 and the holding plate 1, a gas such as N₂ is jetted (purged) unpwardly from the gap G (see, FIG. 2). In the below-described step of rinsing 92 and the step of drying 93, a gas such as N₂ is also jetted (purged) unpwardly from the gap G, so as to prevent a rinse liquid and a liquid for drying or the like from entering the hollow space of the outer rotary shaft 2.

Then, a rinse liquid is supplied to the wafer W by the front-side cleaning-liquid supply part 65 and the rear-side cleaning-liquid supply part 30 (step of rinsing 92) (see, FIGS. 2 and 3). Namely, the rinse liquid is supplied to the front surface of the wafer W by the front-side cleaning-liquid supply part 65, and the rinse liquid is supplied to the rear surface of the wafer W by the rear-surface cleaning-liquid supply part 30.

During the performance of the step of chemical-liquid supplying 91 and the step of rinsing 92, not only that the outer rotary shaft 2 is rotated by the outer rotary drive part 40 so that the wafer W is rotated, but also that the inner rotary shaft 22 is rotated by the inner rotary drive part 10 so that the lift pin plate 20 is rotated. Thus, the cleaning liquids such as the chemical liquid and the rinse liquid used for cleaning the wafer W can be prevented from pooling in the lift pin plate 20, and the cleaning liquids can be prevented from remaining on the lift pin 21.

That is to say, the cleaning liquids such as the chemical liquid and the rinse liquid received by the lift pin plate 20 are moved outward the periphery of the lift pin plate 20 by a centrifugal force generated by the rotation of the lift pin plate 20. Thus, since the cleaning liquids used for cleaning the wafer W are removed from the lift pin plate 20 and the lift pin 21 at any time, pooling of the cleaning liquids in the lift pin plate 20 and remaining of the cleaning liquids on the lift pin 21 can be prevented.

In this embodiment, a distance between a distal end of the lift pin 21 of the lift pin plate 20 and a lower surface of the wafer W held by the holding plate 1 is 5 mm or smaller, when the lift pin plate 20 is located on the lower position (see, FIG. 1(a) and FIG. 2). Thus, the distal end of the lift pin 21 can be cleaned by the chemical liquid and the rinse liquid flowing along the lower surface of the wafer W.

As a result, in the above-described step of supporting 82 and the below-described step of carrying out 96 where the distal end of the lift pin 21 is brought into contact with the rear surface of the wafer W, contaminations adhering to the distal end of the lift pin 21 can be prevented from moving onto the rear surface of the wafer W.

After the step of rinsing 92 has been finished, the step of drying 93 is performed.

Namely, a liquid for drying made of IPA (isopropyl alcohol) or the like is supplied from the front-side cleaning-liquid supply part 65, and a gas for drying made of N₂ or the like is supplied from the rear-side cleaning-liquid supply part 30. Also at this time, the lift pin plate 20 is rotated by the driving force imparted from the outer rotary drive part 40.

Thus, the cleaning liquids (especially the rinse liquid) remaining on the lift pin plate 20 and the lift pin 21 are moved outward the periphery of the lift pin plate 20 by a centrifugal force generated by the rotation of the lift pin plate 20. Therefore, the cleaning liquids (especially the rinse liquid) can be reliably prevented from remaining on the lift pin plate 20 and the lift pin 21.

After the step of drying 93 is finished, the wafer W is raised by the lift pin 21 of the lift pin plate 20, and the wafer W is moved to the wafer transfer robot (step of carrying out 96) (see, FIG. 1(b) and FIG. 3). As described above, during the step of chemical-liquid supplying 91, the step of rinsing 92, and the step of drying 93, since the lift pin plate 20 is continuously rotated, no cleaning liquid remains on the lift pin plate 20 and the lift pin 21.

Therefore, when the wafer W is raised by the lift pin 21 of the lift pin plate 20, there is no possibility that liquid droplets of the cleaning liquid pooling in the lift pin plate 20 and the liquid droplets of the cleaning liquid remaining on the lift pin 21 adhere to the rear surface of the wafer W.

As a result, formation of watermarks on the wafer W itself to which the liquid droplets adhere can be prevented. In addition thereto, formation of watermarks on other wafers W contained in a carrier into which the wafer W has been brought can be prevented.

In this embodiment, since the gap G is provided between the lift pin plate 20 and the holding plate 1, whereby it is possible to differ a rotational speed of the outer rotary shaft 2 rotated by the outer rotary drive part 40 and a rotational speed of the inner rotary shaft 22 rotated by the inner rotary drive part 10 from each other. Thus, in order to more reliably remove the cleaning liquid on the lift pin plate 20, the rotational speed of the lift pin plate 20 can be made faster than the rotational speed of the holding plate 1. Namely, when the surface of the wafer W is desired to be cleaned at a low rotational speed, only the holding plate 1 can be rotated at a low speed (e.g., 100 rpm) while the lift pin plate 20 can be rotated at a high speed (e.g., 1000 rpm). Therefore, pooling of the cleaning liquids in the lift pin plate 20 and remaining of the cleaning liquids on the lift pin 21 can be more reliably prevented.

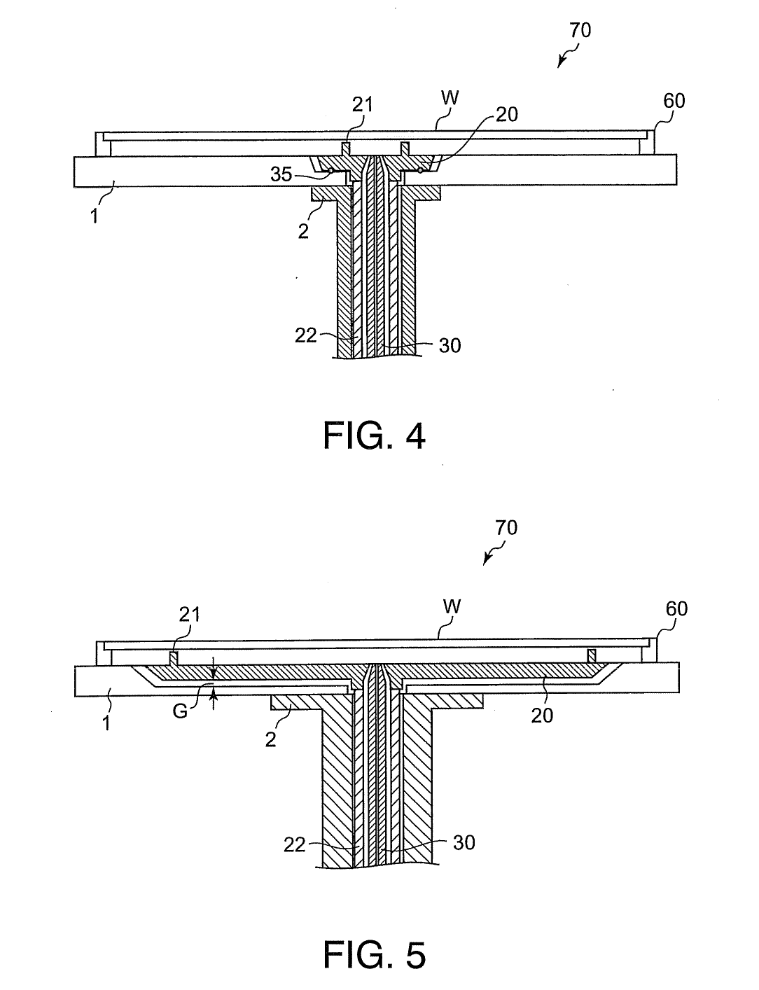

The above embodiment has been described by giving the example in which the gap G is provided between the lift pin plate 20 and the holding plate 1. However, not limited thereto, as shown in FIG. 4, instead of the gap G, a sealing member 35 such as an O-ring may be provided between the lift pin plate 20 and the holding plate 1.

When such a sealing member 35 is provided between the lift pin plate 20 and the holding plate 1, a rotational direction of the outer rotary shaft 2 rotated by the outer rotary drive part 40 and a rotational direction of the inner rotary shaft 22 rotated by the inner rotary drive part 10 have to be the same with each other. In addition, a rotational speed of the outer rotary shaft 2 by the outer rotary drive part 40 and a rotational speed of the inner rotary shaft 22 by the inner rotary drive part 10 have to be the same with each other.

Owing to the provision of the sealing member 35 between the lift pin plate 20 and the holding plate 1, in the aforementioned chemical-liquid supplying step 91, the step of rinsing 92, and the step of drying 93, such as the cleaning liquid, the rinse liquid, and the liquid for drying can be prevented from entering the hollow space of the outer rotary shaft 2 from between the lift pin plate 20 and the holding plate 1.

The above embodiment has been described by giving the example in which the lift pin 21 of the lift pin plate 20 is located in the vicinity of the center of the holding plate 1. However, not limited thereto, as shown in FIG. 5, the lift pin plate 20 may have a circular shape extending up to a position near to the periphery of the holding plate 1, and the lift pin 21 may be located on a position near to the periphery of the holding plate 1.

When the lift pin 21 is located on a position near to the periphery of the holding plate 1, the distal end of the lift pin 21 can be cleaned by the chemical liquid and the rinse liquid which have been used for cleaning the rear surface of the wafer W. Thus, not only when the distal end of the lift pin 21 is brought into contact with the rear surface of the wafer W, contaminations adhering to the distal end of the lift pin 21 can be more reliably prevented from moving onto the rear surface of the wafer W, but also irregular flow of the cleaning liquid on the rear surface of the wafer W can be restrained during cleaning the distal end of the lift pin 21.

In this embodiment, information relating to the respective steps of the above-described liquid processing method is stored in a storage medium 52 (see, FIGS. 1(a) and 1(b)). The liquid processing apparatus 70 includes a computer 55 acceptable to the storage medium 52, and a control part 50 configured to control the liquid processing apparatus 70 based on a signal from the computer 55. Thus, when the storage medium 52 is inserted to the computer 55, the control part 50 can cause the liquid processing apparatus 70 to implement the aforementioned series of liquid processing method (see, FIGS. 1(a) and 1(b)).

1. A liquid processing apparatus comprising:
a hollow holding plate configured to hold an object to be processed;
a hollow outer rotary shaft fixedly joined to the holding plate;
a lift pin plate disposed in a hollow space of the holding plate, and having a lift pin configured to support the object to be processed;
an inner rotary shaft extended in a hollow space of the outer rotary shaft, and fixedly joined to the lift pin plate;
a cleaning-liquid supply part disposed inside the inner rotary shaft, the cleaning-liquid supply part being configured to supply a cleaning liquid to the object to be processed held by the holding plate;
a lifting member configured to raise and lower the lift pin plate so as to locate the lift pin plate on an upper position and a lower position;
an outer rotary drive part joined to the outer rotary shaft, the outer rotary drive part being configured to rotate the outer rotary shaft; and
an inner rotary drive part joined to the inner rotary shaft, the inner rotary drive part being configured to rotate the inner rotary shaft.

2. The liquid processing apparatus according to claim 1, wherein:
a rotational direction of the outer rotary shaft rotated by the outer rotary drive part is the same as a rotational direction of the inner rotary shaft rotated by the inner rotary drive part;
a rotational speed of the outer rotary shaft rotated by the outer rotary drive part is the same as a rotational speed of the inner rotary shaft rotated by the inner rotary drive part; and
a sealing member is provided between the lift pin plate and the holding plate.

3. The liquid processing apparatus according to claim 1, wherein
a distance between a distal end of the lift pin of the lift pin plate and a lower surface of the object to be processed held by the holding plate is 5 mm or smaller, when the lift pin plate is located on the lower position.

4. The liquid processing apparatus according to claim 3, wherein
the lift pin of the lift pin plate is located in the vicinity of a periphery of the holding plate.

5. The liquid processing apparatus according to claim 1, wherein
a rotational speed of the holding plate rotated by the outer rotary drive part and a rotational speed of the lift pin plate rotated by the inner rotary drive part are different from each other.

6. A liquid processing method with the use of a liquid processing apparatus including: a hollow holding plate; a hollow outer rotary shaft fixedly joined to the holding plate; a lift pin plate disposed in a hollow space of the holding plate, and having a lift pin an inner rotary shaft extended in a hollow space of the outer rotary shaft, and fixedly joined to the lift pin plate; a cleaning-liquid supply part disposed inside the inner rotary shaft; a lifting member configured to raise and lower the lift pin plate so as to locate the lift pin plate on an upper position and a lower position; an outer rotary drive part joined to the outer rotary shaft; and an inner rotary drive part joined to the inner rotary shaft; the liquid processing method comprising:
locating the lift pin plate on the upper position by the lifting member;
supporting an object to be processed by the lift pin of the lift pin plate;
locating the lift pin plate on the lower position by the lifting member;
holding the object to be processed by the holding plate;
rotating the outer rotary shaft by the outer rotary drive part, so that the object to be processed held by the holding plate is rotated;
rotating the inner rotary shaft by the inner rotary drive part, so that the lift pin plate is rotated;
supplying a chemical liquid to the object to be processed by the cleaning-liquid supply part; and
supplying a rinse liquid to the object to be processed by the cleaning-liquid supply part.

7. The liquid processing method according to claim 6, wherein
a rotational speed of the object to be processed held by the holding member and a rotational speed of the lift pin plate are different from each other.

8. A storage medium storing a computer program for causing a computer to implement a liquid processing method,
the liquid processing method performed with the use of a liquid processing apparatus including: a hollow holding plate; a hollow outer rotary shaft fixedly joined to the holding plate; a lift pin plate disposed in a hollow space of the holding plate, and having a lift pin; an inner rotary shaft extended in a hollow space of the outer rotary shaft, and fixedly joined to the lift pin plate; a cleaning-liquid supply part disposed inside the inner rotary shaft; a lifting member configured to raise and lower the lift pin plate so as to locate the lift pin plate on an upper position and a lower position; an outer rotary drive part joined to the outer rotary shaft; and an inner rotary drive part joined to the inner rotary shaft;
the liquid processing method comprising:
locating the lift pin plate on the upper position by the lifting member;
supporting an object to be processed by the lift pin of the lift pin plate;
locating the lift pin plate on the lower position by the lifting member;
holding the object to be processed by the holding plate;
rotating the outer rotary shaft by the outer rotary drive part, so that the object to be processed held by the holding plate is rotated;
rotating the inner rotary shaft by the inner rotary drive part, so that the lift pin plate is rotated;
supplying a chemical liquid to the object to be processed by the cleaning-liquid supply part; and
supplying a rinse liquid to the object to be processed by the cleaning-liquid supply part.
